(19) United States
(12) Patent Application Publication
(10) Pub. No.: US 2007/0022169 A1
(43) Pub. Date: Jan. 25, 2007

(54) Device, storage medium storing program and method for registrating/retrieving of information to/from electronic bulletin board

(76) Inventors: Nobuo Suzuki, Tokyo (JP); Yuji Kobayashi, Tokyo (JP); Tatsuomi Kita, Tokyo (JP)

Correspondence Address: GAUTHIER & CONNORS, LLP, 225 FRANKLIN STREET, SUITE 2300, BOSTON, MA, 02110, US

(21) Appl. No.: 11/398,136

(22) Filed: Apr. 5, 2006

(30) Foreign Application Priority Data
Jul. 20, 2005 (JP) 2005-210183

(51) Int. Cl. G06F 15/16

(52) U.S. Cl. 709/206

(57) ABSTRACT

There is provided a mediation device that performs a process for registering or retrieving voice information to or from an electronic bulletin board system in response to a request from a user. The mediation device includes a notifying section that, when an update of the electronic bulletin board is made, produces and transmits notification data to a user related to the update, the notification data including information indicating the update and access information for invoking an operation related to the update, and a request processing section that receives from the user an operation request made with use of the access information, and performs a process for the operation which corresponds to the access information.

### PRIORITY INFORMATION

The entire disclosure of Japanese Patent Application No. 2005-210183 filed on Jul. 20, 2005 including specification, claims, drawings, and abstract is incorporated herein by reference in its entirety.

### BACKGROUND

1. Technical Field

The present invention relates to devices for mediating registration to or retrieval from an electronic bulletin board.

2. Related Art

In recent years, CTI (Computer Telephony Integration) and IVR (Interactive Voice Response) techniques for providing various services through cooperation between telephones and computers have been increasingly utilized. Such techniques are used for supporting operations at a call center and other purposes.

Meanwhile, electronic bulletin boards have been widely used as a mechanism for sharing information among multiple users. Whereas conventionally electronic bulletin boards generally handle text data, a voice bulletin board for allowing users to share voice information using CTI has been proposed in recent years.

Inaconventional system, when a user wishes to enjoy a service of registering (uploading) or retrieving (downloading) voice information to or from a voice bulletin board, the user accesses a bulletin board server from a user terminal, and makes a step-by-step selection from a hierarchical menu provided by the bulletin board server on the terminal. For example, when instructed by the user to retrieve voice information, the bulletin board server sets information, such as the telephone number of the user terminal, the user ID, status, operation, the bulletin board ID, the recorded file name, and the like, in a database of a CTI server. By switching connection from the bulletin board server to the CTI server, the user terminal acquires voice information through the CTI server. The conventional system also includes a mail transmission server for informing other users' terminals of a message update through an e-mail.

According to the above-described conventional system, when a user is informed of a message update from the mail transmission server and wishes to know the content of the update, he/she must access the bulletin board server, and hierarchically make a menu selection from a top menu to choose a desired service, and therefore the user's burden of operation is considerable.

### SUMMARY

According to one aspect of the invention, a mediation device that performs a process for registering or retrieving voice information to or from an electronic bulletin board system in response to a request from a user. The mediation device includes a notifying section that, when an update of the electronic bulletin board is made, produces and transmits notification data to a user related to the update, the notification data including information indicating the update and access information for invoking an operation related to the update, and a request processing section that receives from the user an operation request made with use of the access information, and performs a process for the operation which corresponds to the access information.

### BRIEF DESCRIPTION OF THE DRAWINGS

These and other aspects of the invention will become apparent from the following description read in conjunction with the accompanying drawings wherein the same reference numerals have been applied to like elements and in which:

FIG. 1 shows an example system configuration according to an embodiment of the present invention;

FIG. 2 shows an example configuration of an electronic bulletin board system;

FIG. 3 shows an example of a notification mail sent to a mobile phone (when a voice message is registered);

FIG. 4 shows another example of the notification mail sent to a mobile phone (when a text message is registered);

FIG. 5 shows an example of information stored in a message-operation mapping information storage section;

FIG. 6 shows details of a CTI processing section;

FIG. 7 is a diagram for describing a flow of processing performed when a voice message is played; and

FIG. 8 is a diagram for describing a flow of processing performed when a reply to a voice message is made.

### DETAILED DESCRIPTION

When a user is at his/her terminal, the user can access an electronic bulletin board from a personal computer (PC) through a network, such as the Internet or an intranet, to perform tasks of, for example, browsing or posting a message to the electronic bulletin board in the form of common web services provided conventionally. However, when the user is not at home or in the office and does not carry a portable PC, he/she cannot enjoy an environment of accessing the electronic bulletin board similar to the environment at his/her terminal. On the other hand, as mobile phones capable of transmitting and receiving an e-mail have come into wide use these days, a more user-friendly service can be provided if a mobile phone can be used to obtain information on the electronic bulletin board or to post a message thereon. In view of this situation, the present embodiment provides users with a function of supplying to the users a message posted on the electronic bulletin board in the form of an e-mail or voice, and a function of posting a voice message onto the electronic bulletin board, thereby facilitating use of the electronic bulletin board from a mobile phone or a similar terminal having limited functions.

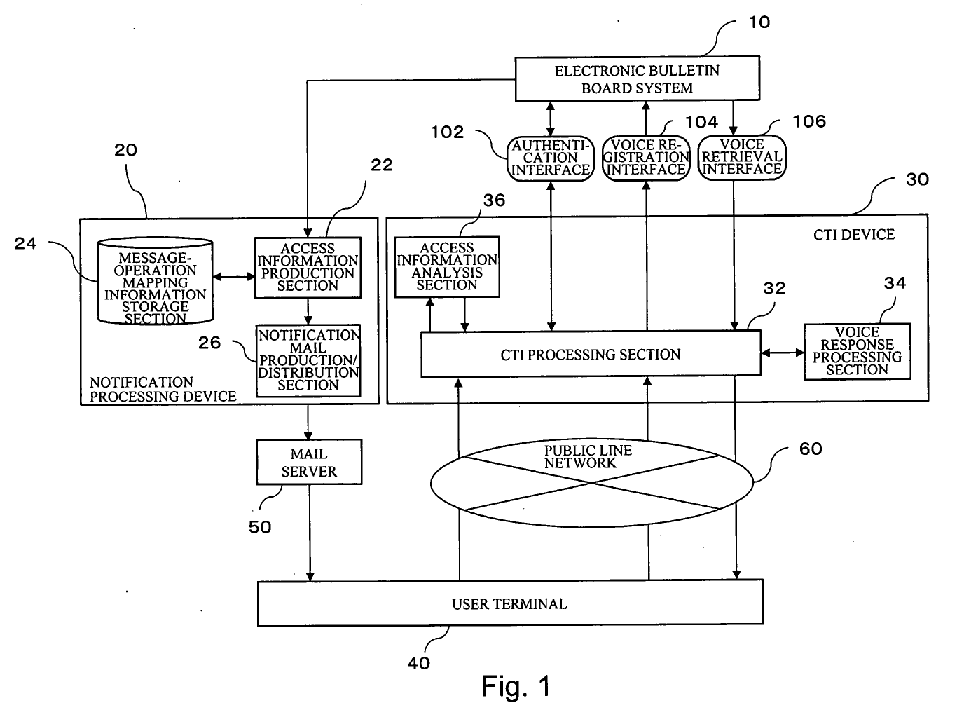

FIG. 1 shows an example configuration of a system according to the present embodiment. The system in this embodiment includes an electronic bulletin board system 10, a notification processing device 20, and a CTI device 30.

The electronic bulletin board system 10 is a system for providing a user with an electronic bulletin board service, and includes a function of registering and providing a voice message in addition to functions of the general electronic bulletin board service through the web.

An electronic bulletin board system (hereinafter referred to as “BBS”) 10 can be used, for example, for sharing information on each task within a company. For such a use, an electronic bulletin board is formed for each task in the system 10, and those employees having duties related to a task are registered as participants in the corresponding bulletin board. The participants in the electronic bulletin board are classified according to authority level; for example, as observers allowed only to browse the bulletin board, members allowed also to post a message, and a leader or moderator of the members, who administers the bulletin board.

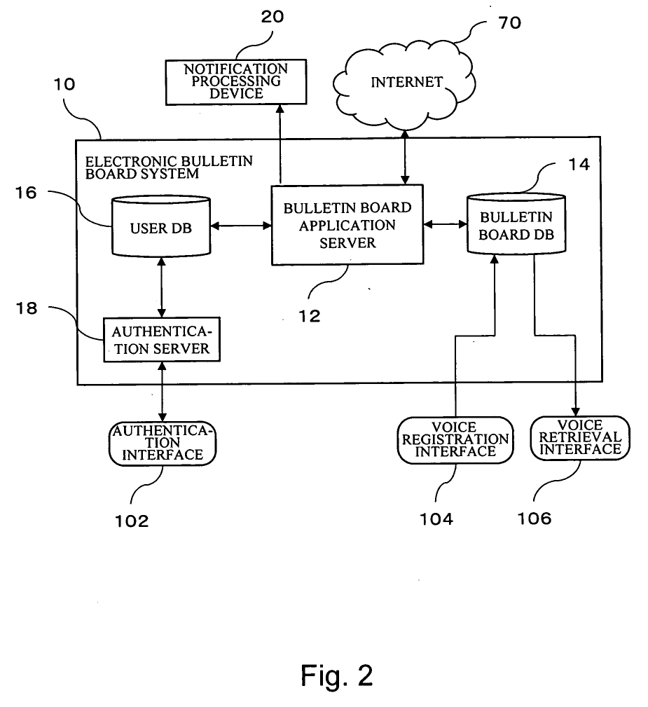

An example of an internal configuration of the electronic bulletin board system 10 is shown in FIG. 2. As shown in FIG. 2, a bulletin board application server 12 is a server for providing users with services of browsing an electronic bulletin board and posting a message thereon in the form of a web application through the Internet 70. For the bulletin board application server 12 itself, an existing server can be basically used.

A bulletin board DB (database) 14 is a database in which information of each of electronic bulletin boards (the information of an electronic bulletin board is , for example, a list of messages posted thereon and attribute information thereof) managed by the electronic bulletin board system 10 is registered, and allows posting of voice messages in addition to text messages. For the bulletin board DB 14, library programs or APIs (application program interfaces); namely, a voice registration interface 104 and a voice retrieval interface 106, are provided for posting a voice message on an electronic bulletin board through the CTI device 30, and retrieving a message posted on the electronic bulletin board, respectively. Outside of these elements, the bulletin board DB 14 may be similar to a commonly used bulletin board DB.

A user DB 16 is a database for managing user information of users registered in the electronic bulletin board system 10. The user information managed by the user DB 16 includes, for example, authentication information, such as a user ID, a user name, and a password, and personal information, such as an e-mail address, of the user. The user DB 16 can also manage access right in formation specifying which type of access right is owned by each user (such as the right only to browse, to browse and post, or no right to browse or post) and for which electronic bulletin boards in the bulletin board DB 14 each user has such a right; i.e. information indicating the category of authority each user has for each electronic bulletin board. Note that such information of access rights can be managed by the bulletin board DB 14.

An authentication server 18 is a server for authenticating a user trying to access the electronic bulletin board system 10. The authentication server 18 receives authentication information entered by the user, and refers to registered information in the user DB 16 to determine whether or not the information is correct. In addition to the function of user authentication for the access through the Internet 70, the authentication server 18 also has a function of accepting an authentication request from the CTI device 30. An authentication interface is provided as a library program or an API for invoking the latter function.

Referring again to FIG. 1, the notification processing device 20 will be described. When a bulletin board is updated (such as when a new message is posted (registered) or an existing message is deleted or changed) in the electronic bulletin board system 10, the notification processing device 20 forms and distributes an e-mail (hereinafter referred to as a “notification mail”) for notifying the related users of the updated contents. The related users are the users, for example, having the access rights of browsing and/or posting a message on the updated bulletin board. For each bulletin board, there can be registered users to whom a notification mail is to be sent when that particular bulletin board is updated. The updated contents of the bulletin board and information on users to receive the notification mail are provided from the bulletin board application server 12.

While systems for notifying users of the bulletin board update via an e-mail have been used, the notification mail provided by a conventional system generally provides a posted message, a poster, and a URL (Uniform Resource Locator) of the message. Although the posted message can be browsed by use of the URL and a reply message can be posted through the web browser if a user terminal 40 is a PC, such actions are impossible with a mobile phone having no web browser function. Even with a mobile phone having the web browser function, it is troublesome to follow links of the electronic bulletin board web page in order to play the posted voice message or register a reply message thereto. In view of this problem, according to the present embodiment, when an electronic bulletin board is updated, a notification mail including not only the updated message but also the access information is created and provided to the related parties. The access information is the information for invoking one or more operations selectable by a user as an operation performed on the message among multiple operations on the electronic bulletin board. Major instances of the operations on the electronic bulletin board are playing a voice message and registration thereof (reply, or registration of a new message on that bulletin board), because it is assumed here that a mobile phone is used. The text message need not be browsed again, because it is written in the notification mail, and inputting a reply to the message or a new message in text is troublesome with a mobile phone. For access information, the format that can be recognized as link information by a mail client software of the user terminal 40, such as a URL, is used. For example, general mail clients for a PC recognize a text string beginning with “http://” as a URL of a web page, and have a function of starting the web browser to access the URL when the text string is clicked. Similarly, mail clients of mobile phones generally have a function of interpreting as a telephone number a number string beginning with “TEL:” or a number string starting with “0” and satisfying the condition of the number of digits in telephone numbers, and calling the telephone number when the number string is clicked. The present embodiment makes it possible to play (retrieve and download) and register (upload) a voice message over telephone lines while using such a telephone number format as access information.

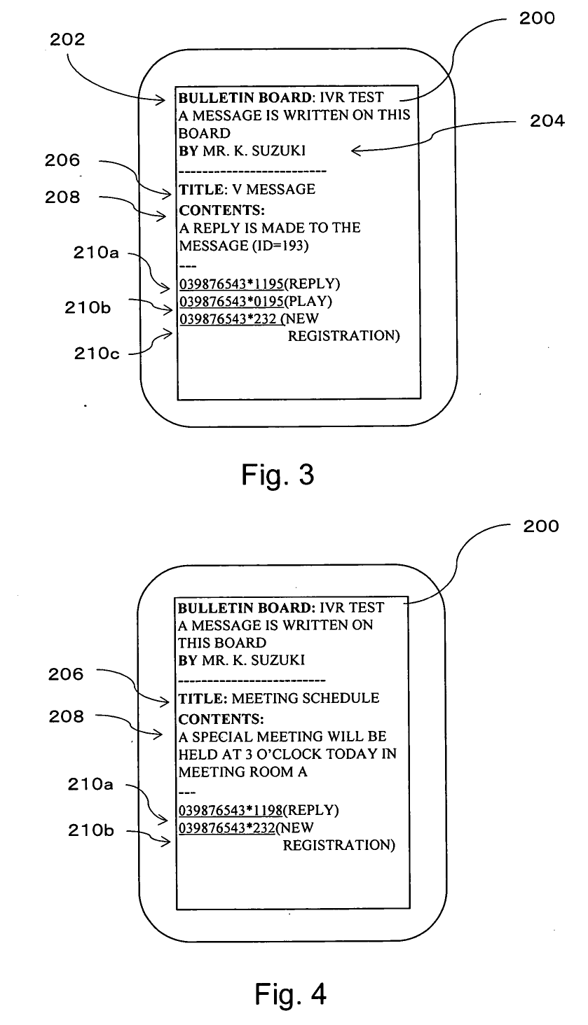

FIGS. 3 and 4 show examples of a notification mail transmitted from the notification processing device 20 to a mobile phone. The notification mail examples in FIGS. 3 and 4 are transmitted to the related parties when a voice message is posted (registered) on an electronic bulletin board, and when a text message is posted, respectively. First, the contents of information in a notification mail 200 are described through the example of FIG. 3.

As shown in FIG. 3, the notification mail 200 includes a name 202 of an electronic bulletin board on which a message is posted, a user name 204 of the poster of the message, a title 206 of the posted message, and a text content 208 of the message. It also includes an access information item 210a for issuing an instruction of a reply operation to the message, an access information item 210b for issuing an instruction of playing the message, and an access information item 210c for issuing an instruction of a posting operation of a new message (not a reply to the posted message) on the bulletin board.

For example, the access information item 210a is formed of a text string “039876543*1195.” The beginning part “039876543” is a telephone number of the CTI device 30 receiving an instruction from the user terminal 40. The asterisk “*” is a predetermined character dividing the telephone number and the following sub address (also referred to as an extension number). The number “1195” is a sub address, which includes the type of operation, and identification information specifying the message or the electronic bulletin board on which the operation is performed (referred to as a message ID and a bulletin board ID, respectively). In the illustrated example, the first number of the sub address indicates the type of operation, and the number “0,” for example, indicates the operation of playing the voice message provided in the notification mail. The number “1” indicates the operation of replying in the form of a voice message to the message provided in the notification mail. The number “2” indicates the operation of posting a new voice message; i.e. not a reply, on the bulletin board where the message is registered. A user reading the notification mail and inspired by the message provided in the mail may wish to post a new message, rather than a reply to the message, on that electronic bulletin board. In such a case, the user uses the new registration operation. In addition to playing, replying, and newly registering a voice message described above as examples, operations for which access information is provided in the notification mail may include an operation of notifying the electronic bulletin board system 10 that the user has browsed the message in the notification mail, an operation of deleting the message, and the like. The browse notification from the user is recorded by the electronic BBS 10. The electronic BBS 10 counts the number of browse notifications from users, thereby obtaining and displaying on the electronic bulletin board, for each message, the number of related users who have browsed the message. For the deleting operation, the electronic BBS 10 may allow this operation only when the requesting user is determined to be the poster of that message (or a person authorized to delete the poster's message) through user authentication.

The 2- or 3-digit number string following the first number of the sub address is an identification number of the target message or electronic bulletin board to be operated. The identification number is uniquely assigned to each of multiple electronic bulletin boards registered in the bulletin board DB 14 and multiple messages posted thereon. The target message is the message to be played or to which a reply is made; i.e., the message provided in the notification mail. The target electronic bulletin board is the electronic bulletin board on which a new message is posted; i.e. the board to which the provided message belongs.

Although the access information item 210a has been described above as an example, the access information items 210b and 210c are configured similarly. Note that next to each of the access information items 210a-210c there is provided a description (such as “reply”) indicating the content of operation of the access information, so that the user looking at the description can specify the access information corresponding to the desired operation.

The notification message, illustrated in FIG. 4, transmitted when a text mail is posted is configured similarly to that in FIG. 3. The greatest point of difference between the two examples is that the example of FIG. 3 includes the access information item 210a for a playing operation because the message provided in the notification mail is a voice message, whereas the example in FIG. 4 does not include the access information item 210a for a playing operation. This is because the content of the message posted on the bulletin board is shown in the column of the text content 208 in the notification mail 200 when the message is a text message, and therefore a playing operation is not necessary.

When a voice message is posted on the bulletin board, the electronic bulletin board system 10 automatically produces the title and text content of the message, and registers the voice message data in the bulletin board DB 14 in association with the title and the text content. Therefore, for the notification mail in the example of FIG. 3 as well, the title 206 and the text content 208 of the message are automatically produced by the electronic bulletin board system 10.

Referring again to FIG. 1, in order to produce and distribute such a notification mail, the notification processing device 20 includes an access information production section 22, a message-operation mapping information storage section 24, and a notification mail production/distribution section 26.

Upon receiving from the electronic bulletin board system 10 a notification of an update of the bulletin board, such as a notification that a message has been posted or updated, the access information production section 22 produces the access information items 210a, 210b, 210c to be written in the notification mail 200. For this action, when a message is posted or updated on the bulletin board, the electronic bulletin board system 10 passes to the notification processing device 20 the bulletin board name and bulletin board ID of the bulletin board, the user name of the posting user, the message ID, title, and text content of the message, and the type of the posted message. The message type indicates, for example, whether the message is a text message or a voice message. The access information production section 22 produces the access information item 210a and the like to be contained in the notification mail 200 by referring to the message-operation mapping information storage section 24 on the basis of information, such as the bulletin board ID, message ID, and message type thereof.

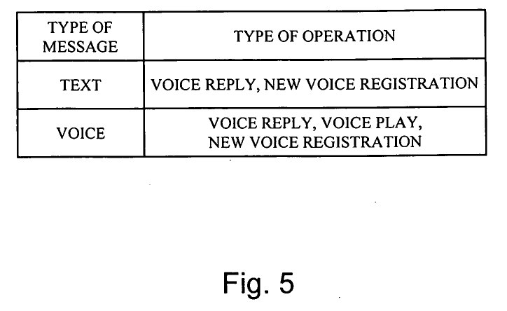

The message-operation mapping information storage section 24 stores, for each message type, the types of operations that can be performed on that type of the message. FIG. 5 shows an example. In the example of FIG. 5, operations of making a voice message reply and registering a new voice message are registered for a text message, whereas for a voice message an operation of playing the voice message is registered, in addition to the voice message replying operation and the new voice message registration operation. The access information production section 22 acquires from the message-operation mapping information storage section 24 the operation type corresponding to the type of the posted or updated message serving as the subject of notification by the electronic bulletin board system 10. For each type of operation, the section 22 combines an operation type code (0, 1, or 2 in the above-described example) with the message ID (for play and reply) or the bulletin board ID (for new registration) provided by the electronic BBS 10, thereby producing the sub address of the access information. The access information production section 22 adds such a sub address after the reception telephone number of the CTI device 30, thereby producing the access information item 210a and the like corresponding to each operation.

The notification mail production/distribution section 26 produces a notification mail including the bulletin board name, the user name, the title of a message, and the text content provided by the electronic bulletin board system 10, and the access information item 210a and the like produced by the access information production section 22 in the main body. The notification mail is addressed to each registered user of the bulletin board on which the message of interest is registered (user having the right to access that bulletin board), and the e-mail address of each registered user can be acquired from the user DB 16 of the electronic BBS 10. The notification mail production/distribution section 26 transmits to each addressee the thus-produced notification mail through a mail server 50, such as an SMTP server.

Although a notification mail designed for a mobile phone is described above, a conventional mail including a URL of the message and the like can be sent as the notification mail to a PC. Alternatively, similar to the mail for a mobile phone, the notification mail for a PC may also include the access information item 210a and the like for each operation.

The user terminal 40 receiving the notification mail can perform a variety of operations as a response to the message using the access information item 210a, the URL, and the like written in the notification mail. When the user terminal 40 is a mobile phone and the user selects the access information item 210a and the like in the notification mail 200, the mail client uses the selected access information to perform a calling process. The call thus made is received by the CTI device 30 through a public line network 60 (including a mobile phone network).

The CTI device 30 receives an operation request made with use of a control signal of the public line network 60 or voice from the user terminal 40, such as a mobile phone, through the telephone line (public line network 60), and performs a process in response to the operation request. A CTI processing section 32 serves as the backbone of the CTI device 30, performing such processes as retrieving information of the calling user and input information thereof from a variety of control signals or DTMF (Dual Tone Multi-Frequency) signals from the user terminal 40, and performing a process on the electronic BBS 10 on the basis of such information. A voice response processing section 34 produces a voice response used for guidance provided to the user and other purposes required by the CTI processing section 32 to perform the process. An access information analysis section 36 analyzes the sub address transmitted from the user terminal 40, thereby acquiring the type of operation requested by the user, and the ID of the target message or bulletin board.

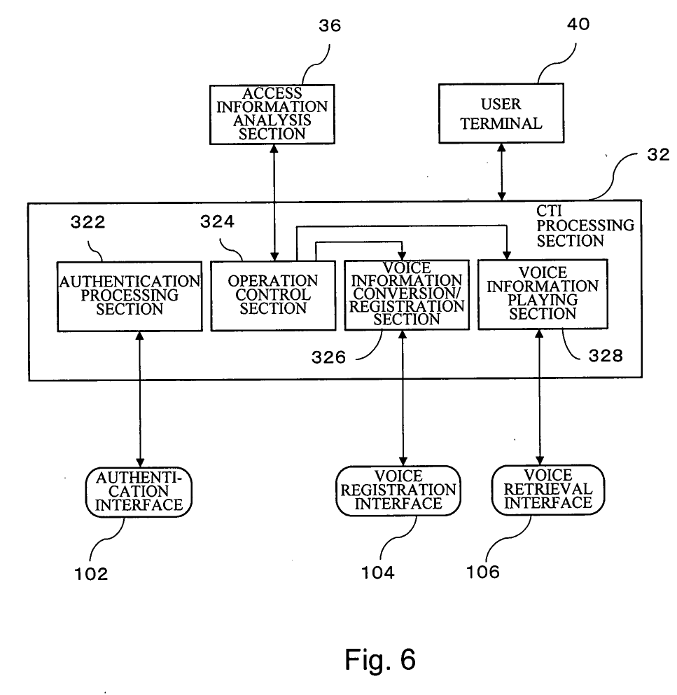

Details of the CTI processing section 32 will be described with reference to FIG. 6. An authentication processing section 322 provided in the CTI processing section 32 performs a process for user authentication and verification of user's access rights on the basis of information, such as a caller number and PIN (Personal Identification Number) information of the user acquired from the telephone line. More specifically, the authentication processing section 322 invokes an authentication interface 102 (library program or API) using as arguments information of the caller number, PIN information, and the sub address (or the operation type obtained by analyzing the address, and the message ID or the bulletin board ID), thereby requesting the authentication server 18 of the electronic bulletin board system 10 to authenticate the user and verify the access right of the user for the message. User authentication is performed on the basis of the caller number and the PIN information. For the access right verification, a determination is made as to whether or not the user is allowed to perform the specified type of operation on that message or bulletin board on the basis of the target message ID or bulletin board ID, and information of the operation type. The techniques for user authentication and access right verification have conventionally been known, and therefore will not be further described herein.

The authentication processing section 322 proceeds with the operation request from the user if it receives a response from the authentication server 18 that the authentication has succeeded, and performs a predetermined error processing if it has failed. Further, if it receives a response that the operation requested by the user is determined to be acceptable as a result of access right verification from the authentication server 18, the section 322 informs an operation control section 324 of the response. If the operation requested by the user is determined to be unacceptable as a result of access right verification, the CTI processing section 32 performs predetermined error processing.

The operation control section 324 assesses the user's request by reference to the sub address transmitted from the user terminal 40, and activates a voice information conversion/registration section 326 or a voice information playing section 328 in accordance with the assessment result. The assessment of the contents of the request from the sub address is performed by the access information analysis section 36 at the request of the operation control section 324.

If the requested type of operation is assessed as a voice response or a new voice message registration, the voice information conversion/registration section 326 is activated, and the target message ID or bulletin board ID (extractable from the sub address) is passed to the voice information conversion/registration section 326. The voice information conversion/registration section 326 converts the voice transmitted via the telephone line from the user terminal 40 to a file in a predetermined voice file format, and invokes a voice registration interface 104 using as arguments the file and the target message ID (if a response is to be made) or bulletin board ID (for a new registration) . The invoked voice registration interface 104 accesses the bulletin board DB 14, and registers the voice file in the bulletin board DB 14 as a reply to the message having that message ID or a new message for the bulletin board having that bulletin board ID. For a reply, the reply message is registered as a child of the original message (shown in the notification mail) in a group of threads formed by a group of messages on the bulletin board. For a new message, the message is registered at the highest level as the first message of a new thread of the bulletin board.

When the type of operation requested by the user is to play a voice message, the operation control section 324 activates the voice information playing section 328 and passes the target message thereto. The voice information playing section 328 invokes a voice retrieval interface 106 while using the message ID as an argument. The voice retrieval interface 106 retrieves from the bulletin board DB 14 a voice file registered in correspondence to the message ID, and passes the file to the voice information playing section 328. The voice information playing section 328 plays the voice file, and transmits the played voice to the requesting user terminal via the telephone line.

Although not shown, when the type of operation requested by the user is a browse notification indicating that the user has browsed the message, the CTI processing section 32 invokes an API for browse notification registration while using as arguments the target message ID and the user ID of that user, thereby registering in the bulletin board DB 14 the fact that the user has browsed the message. When the requested operation is deletion of a message, the CTI processing section 32 invokes an API for deletion while using the target message ID as an argument, thereby deleting the message from the bulletin board DB 14.

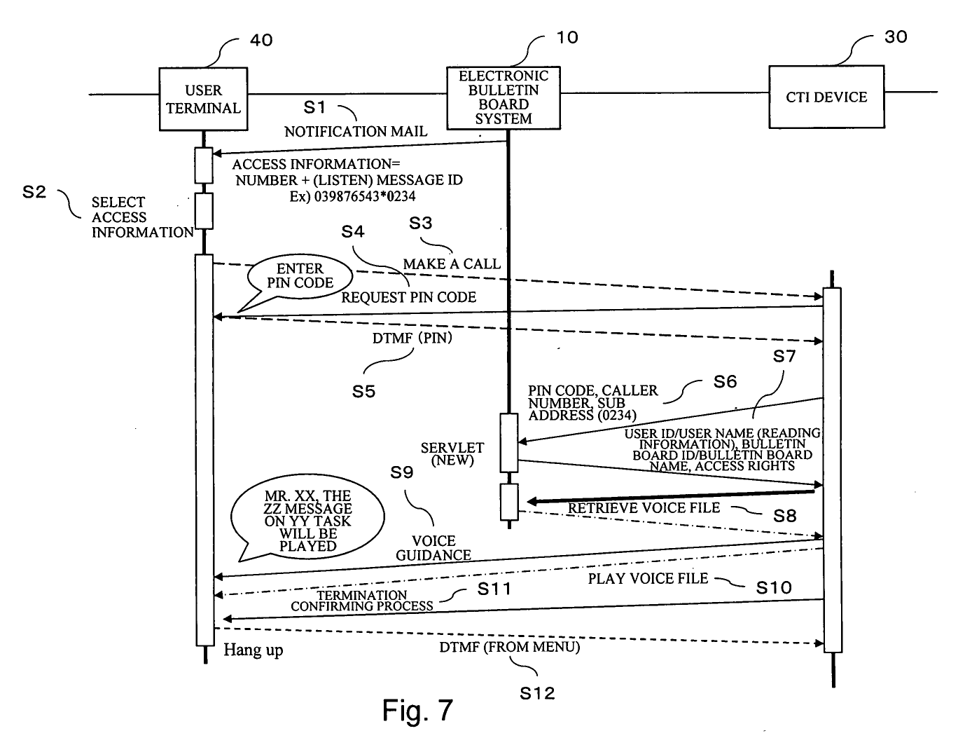

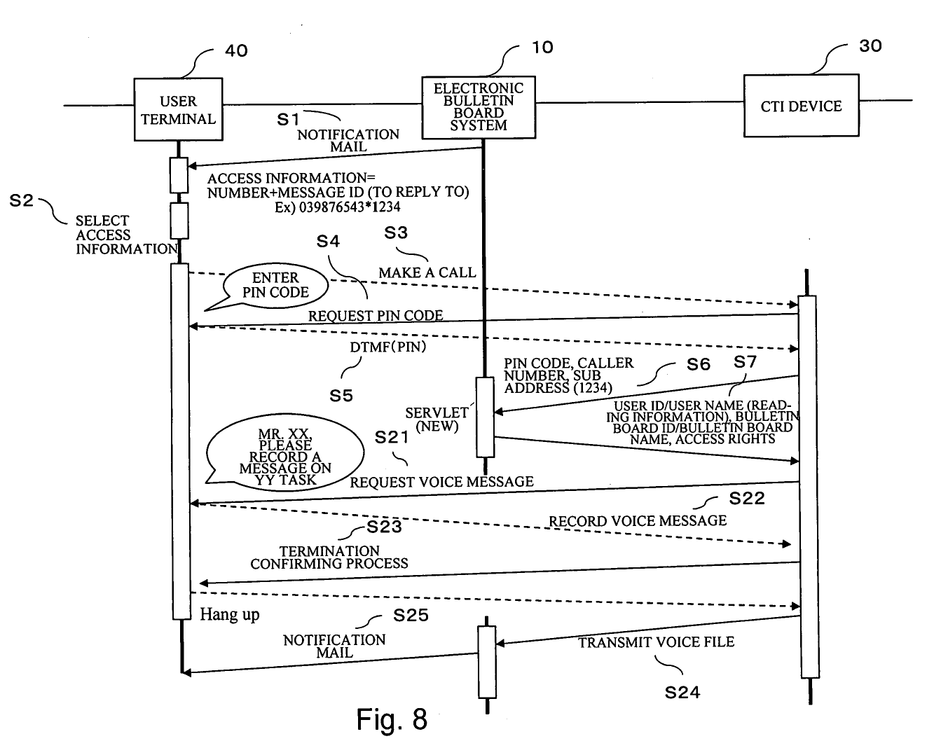

The flow of processes in the present embodiment will next be described with reference to FIGS. 7 and 8. First, a flow of processes for playing a voice message will be described with reference to FIG. 7.

In this process flow, when a message is registered in the electronic bulletin board system 10, a notification mail is transmitted from the notification processing device 20 to a user related to the message (S1). The notification mail includes access information for invoking various operations related to the message. For example, for an operation of listening to (playing) the voice message, the access information includes the telephone number of the CTI device 30, a code indicating the “listening” operation, and the ID of the target message. When, by means of the user terminal 40 receiving the notification mail, the user selects the access information corresponding to a desired operation on a screen where a mail client is displayed (S2), the mail client invokes a calling function of the user terminal 40, and calls the CTI device 30 by use of the access information (S3). At this moment, the CTI device 30 acquires information, such as the caller number, the sub address, and the like of the user terminal 40, from the telephone line.

The CTI device 30 asks the user terminal 40 for the PIN code (S4). This request is made by producing voice guidance, such as “Enter the PIN code,” with the voice response production section 34, and transmitting it to the user terminal 40 via the telephone line. When the user enters the PIN code with a numeric key pad of the user terminal 40 receiving the guidance, the PIN code is transmitted to the CTI device 30 in the form of DTMF signals (S5) Although some telephone line providers may delete the sub address included in the call at a telephone switching station or the like, in such a case the user may be requested to enter the sub address in accordance with voice guidance, similar to the case of the PIN code request.

Upon receiving the PIN code, the CTI device 30 invokes the electronic bulletin board system 10, and passes thereto the caller number, the PIN code, and the sub address data to request user authentication and access right verification (S6). Although in the present example the electronic BBS 10 makes a determination of operation type and operation target from the sub address, the CTI device 30 may make such a determination, and provide the electronic BBS 10 with information of the operation type and operation target obtained as a result of the determination. As a result, a servlet for authentication service is activated in the electronic BBS 10. This servlet performs user authentication and access right verification. The authentication servlet determines that the user is not an authorized user if, for example, the PIN code does not correctly correspond to the caller number (authentication fails). For this determination, the telephone number and the PIN code of each user are registered in the user DB 16. The authentication servlet determines failure of authentication when the caller number is not transmitted from the user terminal 40 for the reason that, for example, the phone is in a caller number blocking mode. When user authentication based on the caller number and the PIN code succeeds, the authentication servlet retrieves from the bulletin board DB 14 the bulletin board ID corresponding to the target message ID, and determines from the user DB 16 or the bulletin board DB 14 whether or not that particular user has an R (reading) right for that bulletin board ID. If the user does not have the R right, authentication fails. In the case of authentication failure, the authentication servlet informs the CTI device 30 of the failure, and the device 30 performs predetermined error processing in response thereto (not shown)

If the user authentication succeeds and the user's access right for the operation is verified, the authentication servlet provides the CTI device 30 with information indicating success of authentication, the user ID and user name (and reading information thereof) of that user, the bulletin board ID and bulletin board name of the bulletin board where the message to be played is registered, and information of the access right that the user owns for the bulletin board (S7). The reading information of the user name will be used when, for example, the user's name is pronounced during voice guidance in a later process.

When authentication succeeds, the CTI device 30 specifies the ID of the target message, and sends a request to the electronic bulletin board system 10 for retrieving a voice message corresponding to that ID. Upon receiving the request, the electronic BBS 10 activates the servlet corresponding to the request, and the servlet retrieves from the bulletin board DB 14 a voice file corresponding to the message ID, and provides the file to the CTI device 30 (S8).

While downloading the voice file (S8), the CTI device 30 provides the user terminal 40 with voice guidance indicating that the message will be played via the telephone line (S9). In the illustrated example, voice guidance including the user name, the bulletin board name, and the message ID (or the message title) is provided. When the voice file has been completely downloaded, the CTI device 30 plays the voice file, and supplies the played voice to the user terminal 40 via the telephone line (S10).

After playing the voice file is complete, the CTI device 30 performs a process of verifying termination (S11). In the termination verifying process, guidance voice saying, for example, “Press 1 to listen to the message again, 2 to finish the playing, or 3 to record a reply,” is transmitted to the user terminal 40. In response to the guidance, the user terminal 40 transmits to the CTI device 30, as the DTFM signal, the user's choice (S12). The CTI device 30 plays the voice file again when the user selects listening to the message again, and converts the voice transmitted from the user terminal 40 to a file and registers it in the electronic BBS 10 when the user selects recording of a reply. Recording a reply is allowed only when that particular user has a W (writing) right for the bulletin board of interest, and in such a case the voice guidance for recording a reply is also provided.

A flow of processing performed when a reply is made to a voice message will be described with reference to FIG. 8. In FIG. 8, steps similar to those in FIG. 7 are labeled with the same numerals, and descriptions thereof are not repeated.

When a notification mail is sent to the user terminal 40 in response to posting of a message on the electronic bulletin board system 10 (S1) and a user selects access information for a reply (S2), a call is made to the CTI device 30 from the user terminal 40 (S3). The CTI device 30 receives input of the PIN code from the user (S4,5), and verification of access rights and user authentication from the electronic BBS 10 using information including the PIN code (S6,7).

When user authentication succeeds, the CTI device 30 transmits to the user terminal 40 a message prompting the user to record a voice message (S21), and in response thereto the user records a voice message (S22). The CTI device 30 performs a process of confirming termination if predetermined termination conditions, such as lapse of a predetermined time period or duration of silence in the call for a predetermined time period from the start of recording, are satisfied (S23). In the termination confirming process, a guidance voice is transmitted to the user terminal 40, such as “Do you wish to end voice recording? Press 1 for Yes, 2 to record from the beginning, or 3 to check the recorded message,” and the device receives the user's response as the DTMF signal. If a restart is instructed, the recording process (S21,22) is repeated. If checking of the message is instructed, the recorded voice is played and transmitted to the user terminal 40, and the termination confirming process (S23) is performed again. If the user selects “Yes,” the CTI device 30 transmits the voice file of the recorded voice to the electronic bulletin board system 10 to request registration (S24). In the electronic BBS10, a servlet for a voice registration process is activated. The servlet registers in the bulletin board DB 14 the voice file, and a title and text content of the message automatically produced, and supplies necessary information to the notification processing device 20, thereby instructing the device 20 to transmit a notification mail for the registered voice message (S25).

Although an example of making a reply is described with reference to FIG. 8, similar processes can be performed for posting a new voice message on a bulletin board.

Further, although in the examples illustrated in FIGS. 7 and 8 a user is requested to enter the PIN code for user authentication, such an entry is not always necessary.

Although in the above example an update of the electronic bulletin board is notified to related users via an e-mail, various notification methods other than an e-mail, such as an instant message and a Short Message Service (SMS), can be used, and the method of the present embodiment is also applicable to such notification methods.

Further, although in the above example the electronic bulletin board system 10, the notification processing device 20, and the CTI device 30 are described as separate devices, such elements only suggest the allocated functions. In implementing each function in an actual hardware device, each of these functions may be performed by separate devices as in this embodiment, two or three of these functions may be integrally performed by a single device, or each function may be divided and implemented by multiple devices.

Although the user terminal 40 has been described as a mobile phone as a chief example, the above-described method of the present embodiment is applicable to any terminals other than mobile phones capable of transmitting and receiving voice through a telephone line.

Although an exemplary form of the present invention has been described in its form with a certain degree of particularity using specific examples, it is to be understood that the invention is not limited thereto. It is further understood by those skilled in the art that various changes and modifications may be made in the invention without departing from the spirit and scope thereof.

What is claimed is:

1. A mediation device that performs a process for registering or retrieving voice information to or from an electronic bulletin board system in response to a request from a user, the mediation device comprising:
a notifying section that, when an update of the electronic bulletin board is made, produces and transmits notification data to a user related to the update, the notification data including information indicating the update and access information for invoking an operation related to the update; and
a request processing section that receives from the user an operation request made with use of the access information, and performs a process for the operation which corresponds to the access information.

2. The device according to claim 1, further comprising a CTI device for acquiring the operation request from a terminal of the user through a telephone line, wherein
the request processing section performs a process in accordance with the operation request acquired by the CTI device.

3. The device according to claim 2, wherein
the access information includes a telephone number of the CTI device, operation type information indicating a type of an operation corresponding to the access information, and target identification information indicating a message or the electronic bulletin board which is a target of the operation.

4. The device according to claim 3, wherein
the access information includes the operation type information and the target identification information in a form of a sub address number attached to the telephone number of the CTI device.

5. The device according to claim 1, wherein
the access information includes operation type information indicating a type of an operation related to a message, and target identification information indicating the message or the electronic bulletin board which is a target of the operation.

6. The device according to claim 1, wherein
the notifying section includes mapping information indicating one or more operations corresponding to a type of a message posted on the electronic bulletin board and, when a message is posted on the electronic bulletin board, obtains one or more operations corresponding to the type of the message from the mapping information, and produces the notification data including the access information for invoking each of the obtained operations.

7. The device according to claim 1, wherein
the notification section produces, when the message posted on the electronic bulletin board is a voice message, the notification data including the access information for invoking the operation corresponding to the voice message, and, when the message posted thereon is a text message, the notification data including the access information for invoking the operation corresponding to the text message.

8. A storage medium storing a program of instructions executable by a computer to cause the computer to perform a function as a mediation device for registering or retrieving voice information to or from an electronic bulletin board system in response to a request from a user, the function comprising:
producing, when an update of the electronic bulletin board is made, notification data which includes information indicating the update and access information for invoking an operation related to the update;
transmitting the notification data to a user related to the update;
receiving from the user an operation request made with use of the access information; and
performing a process for the operation which corresponds to the access information.

9. The storage medium according to claim 8, wherein the access information includes a telephone number of a CTI device which is provided to the computer, operation type information indicating a type of an operation corresponding to the access information, and target identification information indicating a message or the electronic bulletin board which is a target of the operation.

10. The storage medium according to claim 9, wherein the access information includes the operation type information and the target identification information in a form of a sub address number attached to the telephone number of the CTI device.

11. The storage medium according to claim 8, wherein the access information includes operation type information indicating a type of an operation related to the message, and target identification information indicating the message or the electronic bulletin board which is a target of the operation.

12. The storage medium according to claim 8, wherein when the message posted on the electronic bulletin board is a voice message, notification data including the access information for invoking the operation corresponding to the voice message is produced, and, when the message posted thereon is a text message, notification data including the access information for invoking the operation corresponding to the text message is produced.

13. A method executed by a mediation device that performs a process for registering or retrieving voice information to or from an electronic bulletin board system in response to a request from a user, comprising:
producing, when an update of the electronic bulletin board is made, notification data which includes information indicating the update, and access information for invoking an operation related to the update;
transmitting the notification data to the user related to the update;
receiving from the user an operation request made with use of the access information; and
performing a process for the operation which corresponds to the access information.

14. The method according to claim 13, wherein
the access information includes a telephone number of a CTI device which is provided to the computer, operation type information indicating a type of an operation corresponding to the access information, and target identification information indicating a message or the electronic bulletin board which is a target of the operation.

15. The method according to claim 14, wherein
the access information includes the operation type information and the target identification information in a form of a sub address number attached to the telephone number of the CTI device.

16. The method according to claim 13, wherein
the access information includes operation type information indicating a type of an operation related to the message, and target identification information indicating the message or the electronic bulletin board which is a target of the operation.

17. The method according to claim 13, wherein
when the message posted on the electronic bulletin board is a voice message, notification data including the access information for invoking the operation corresponding to the voice message is produced, and, when the message posted thereon is a text message, notification data including the access information for invoking the operation corresponding to the text message is produced.
